(19) United States
(12) Patent Application Publication
(10) Pub. No.: US 2014/0372156 A1
(43) Pub. Date: Dec. 18, 2014

(54) Ticket Scalping Prevention Using a Networked System and Re-Usable Auxiliary Devices

(71) Applicant: Marcus Jamal Floyd, culver city, CA (US)

(72) Inventor: Marcus Jamal Floyd, culver city, CA (US)

(73) Assignee: PHANTEYE, culver city, CA (US)

(21) Appl. No.: 13/920,089

(22) Filed: Jun. 18, 2013

(51) Int. Cl. G06Q 10/02

(52) U.S. Cl. CPC G06Q 10/02
USPC 705/5

(57) ABSTRACT

A networked server system which can be organized in both a centralized and decentralized fashion that prevents ticket scalping, uses multi-use auxiliary devices instead of tickets allowing tickets to be transferred between individuals and resold within the system, eliminates the need for paper tickets, and provides greater anti-fraud and anti-counterfeiting security.

### BACKGROUND OF THE INVENTION

The present invention relates to a re-usable auxiliary device connected to a networked server system that can be used to gain entrance to multiple events and is used in a method to prevent ticket scalping.

In the live entertainment industry, an issue that plagues event promoters, performers, and event attendees is ticket scalping. Ticket scalping creates a secondary market for interested event attendees to acquire tickets. Ticket scalpers will buy tickets directly from a promoter or a ticket broker at a set price and resell them at a higher value, keeping the premium for themselves. By profiting off the premium, ticket scalpers are adding to the face value of a ticket, ticket scalping reduces the net profit that a promoter could have made from ticket purchases. Event attendees ultimately have to pay extra for a ticket. Although ticket scalping is illegal in most states and local governments, it is difficult to enforce the laws that prohibit the act.

When there is a famous act and it is getting closer to the day of the show, these prices become extremely exorbitant. This is an issue for performers who care about their fans because they want them to have a good chance of retrieving tickets at a fair price.

Few companies have tried to mitigate ticket scalping. Methods put in place to prevent scalping are usually set up between the promoter, performer, and the entity who is selling tickets. Methods used today are: limiting the amount of tickets an individual can buy; paperless ticketing which includes presenting and swiping the credit card that was used to purchase the tickets; including a picture of the attendee on the actual ticket for identification of the individual at the entrance of the event; will-call only tickets so the event attendee has to pick up their ticket(s) when they arrive at the venue and provide adequate identification.

While the ahovementioned methods are useful for aiding in the prevention of ticket scalping, some of them are illegal in some local governments and others are too troublesome to manage effectively. Limiting the amount of tickets still does not prevent the act of scalping as an individual can still acquire tickets to a popular event and directly resell them above face value or through a third party. Paperless ticketing can be troublesome as credit cards can wear out and become demagnetized prior to the event. Also, if this individual purchased multiple tickets for other attendees, all attendees must arrive at the event together to gain access as there is no ticket that can be left in will-call to be retrieved later if an individual is running late. This method has received several negative criticisms and has been banned in New York. Having identification information on an individual's ticket is an effective method for limiting ticket scalping, but issues arise when the individual can no longer attend the event as that ticket is not transferable. There are no measures for returning or selling the ticket in this case. Will-call only events also help to limit ticket scalping, but does not prevent it. A ticket scalper can acquire extra tickets and sell them right after they receive them at the venue. In most cases the ticket scalper has already made prior arrangements to resell the tickets to an interested party.

It is desirable to provide a system for promoters and performers which address the “loopholes” and pitfalls with the current methods for limiting and preventing ticket scalping.

### SUMMARY OF THE INVENTION

In accordance with the teachings of the present invention, a method for preventing ticket scalping is provided. It has been determined that for the purpose of the present invention, paper tickets will not prevent ticket scalping while avoiding the pitfalls in current method for preventing ticket scalping. The method includes the steps of purchasing a ticket on the system for oneself and/or for others. If a ticket is purchased for the individual that is making the purchase, the ticket is assigned to the individual automatically. If tickets are purchased for other individuals, the individuals must be a member of the system and the tickets must be assigned to those individuals at the time of purchase. The method also provides for a way to assign tickets to individuals without them knowing for the purpose of a gift.

It is accordingly an object of the present invention to provide a method for assigning auxiliary devices to individuals who purchase them. The system uses an auxiliary device which includes but is not limited to devices that can transmit and/or receive wireless signals including but not limited to radio frequencies, microwave, and bluetooth technologies; devices with a magnetic stripe; a barcode unique to individual members of the system. These devices have unique identifiers that are associated with individual members of the system within the systems database. When a ticket is purchased, the ticket is assigned to the member who is associated with a device that the member previously had in their possession or is issued by the system.

It is another object of the present invention to provide a method for individuals to forfeit their ticket to be absorbed back into the ticketing pool within the system if one is not able to attend an event. The ticket will be sold at face value on the system to other individuals. If the ticket is for general admission, forfeited tickets receive priority over unsold tickets in the pool when an individual is making a purchase. The individual who originally purchased the ticket is refunded their money after their ticket is purchased.

It is another object of the present invention to provide a method for verifying the validity and authenticity of the auxiliary devices being presented for entrance into an event. An auxiliary device is presented to be scanned for validity. The scanner scans information on the device and sends it to the system to verify its authenticity and validity. if the system determines the device is not valid or authentic, it returns an error to the scanner. If the system determines the device is authentic and valid, it then checks to see if a ticket for the event was assigned to the member. Where identification verification is enforced, if the attendee cannot provide proof of identification then they are denied entrance into the event.

### BRIEF DESCRIPTION OF THE DRAWINGS

Additional benefits and advantages of the present invention will become apparent to those skilled in the art to which this invention relates from the subsequent description of the preferred embodiments and the appended claims, taken in conjunction with the accompanying drawings in which:

FIG. 1 is a flow diagram of the ticket purchase process.

FIG. 2 is a flow diagram of the auxiliary device assignment process.

FIG. 3 is a flow diagram of the ticket forfeiture process.

FIG. 4 is a flow diagram of the ticket verification and authentication process.

FIG. 5 is a diagram showing how members and auxiliary devices interface with the system.

### DETAILED DESCRIPTION

In the following description, for purposes of explanation and not limitation, specific details are set forth, such as particular techniques and applications in order to provide a thorough understanding of the present invention. However, it will be apparent to one skilled in the art that the present invention may be practiced in other embodiments that depart from these specific details. In other instances, detailed descriptions of well-known methods and apparatuses are omitted so as not to obscure the description of the present invention with unnecessary details.

Embodiments of the invention provide a method for preventing ticket scalping by using an auxiliary device that is specifically assigned to an individual; a method for transferring a purchased ticket to an individual; a method for forfeiting a purchased ticket that the ticket pool absorbs to be resold at face value; a method for verifying the auxiliary device when an attendee is seeking entrance to an event.

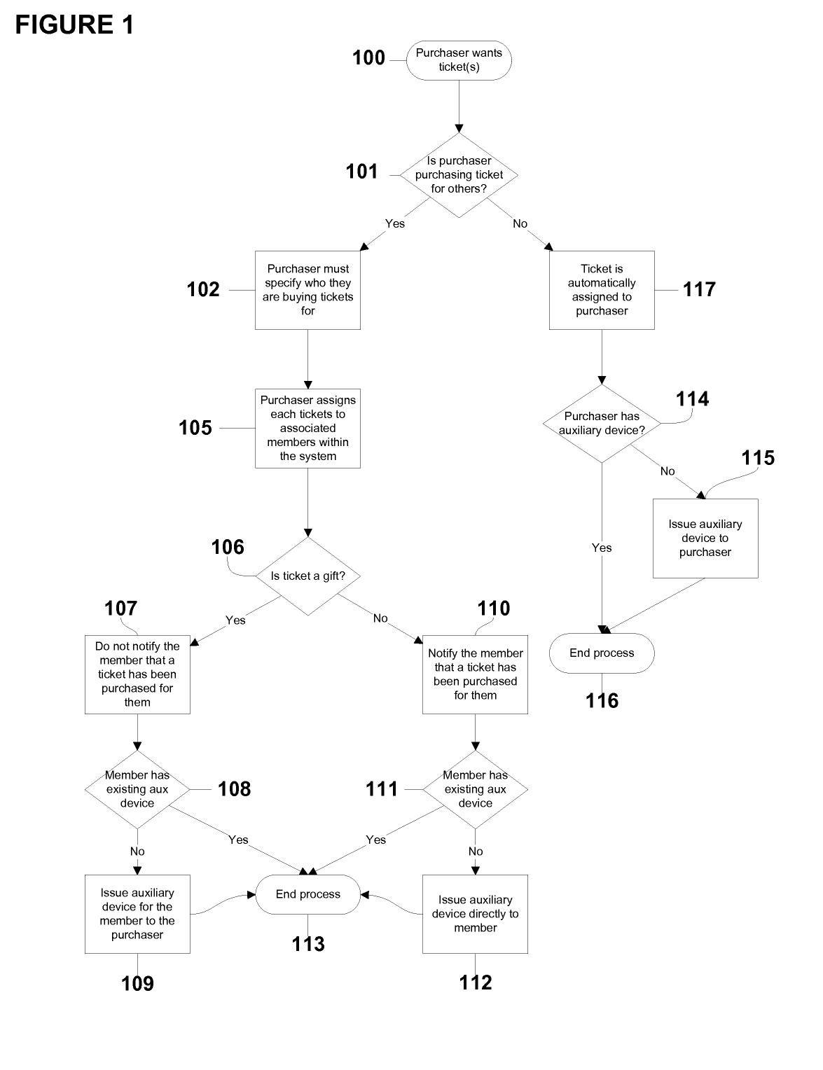

FIG. 1 is a flow chart of the ticket purchase process. As a purchaser purchases tickets 100, the system determines whether the purchaser is purchasing multiple tickets or not 101. Upon determining that the purchaser is purchasing multiple tickets, the purchaser is prompted to select who the additional tickets will be assigned to 102. The purchaser cannot complete the purchase process without selecting Who the additional tickets are for 102. In order to assign a ticket to another member, the purchaser must be linked to the member within the system 105. Upon successful assignment of the ticket, the purchaser must decide whether the ticket is a gift, meaning they don't want the member to know about the ticket 106. If the ticket is a gift, then the member will not be notified about the new ticket 107. The system will determine if the member has an existing auxiliary device 108. If an auxiliary device has not been issued to the member yet, a device for the member will be sent to the purchaser 109 and subsequently, the process is completed 113. If the member has an existing auxiliary device recorded in the system database, the process is completed 113 without the member knowing. If the ticket is not a gift, the system will notify the member 110 and determine whether the member has an existing auxiliary device 111. If the member does not have an existing auxiliary device then one is issued directly to the member 112 and the process is completed 113. If the member does have an existing auxiliary device, then the process is completed 113. If the purchaser is purchasing a single ticket for themselves, the ticket is assigned to the purchaser 117. The system determines whether the purchaser has an auxiliary device 114. If the purchaser has an auxiliary device, then the process is completed 116. If the purchaser does not have an auxiliary device, then a device is provisioned in the system and sent to the purchaser 115 which completes the process 116.

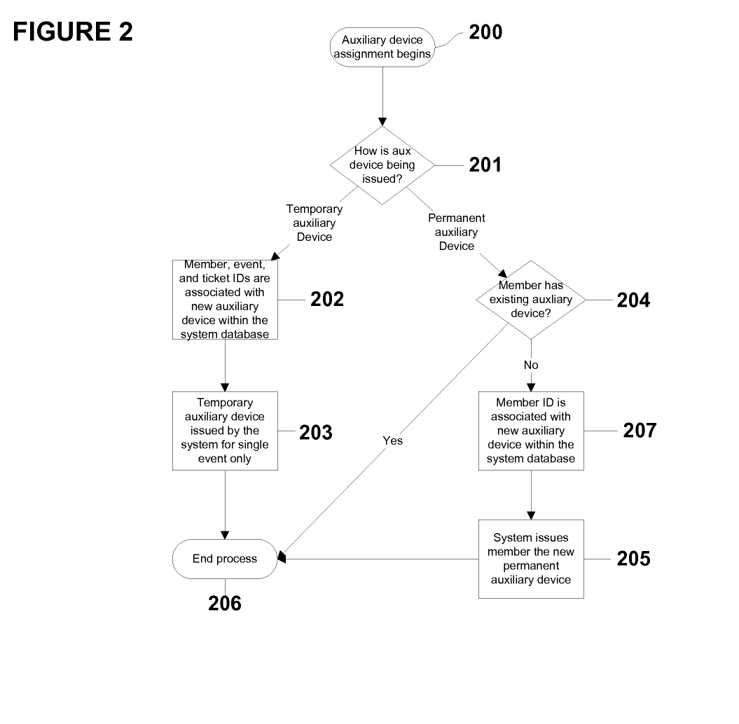

FIG. 2 is a flow chart of the auxiliary device assignment process. As the auxiliary device assignment process begins 200, the system database is checked to determine whether a temporary or a permanent auxiliary device is to be issued to the member 201. if a temporary auxiliary device is being used, it is provisioned. The member ID, event ID, and ticket ID are associated to the new device within the system database 202. The temporary auxiliary device is issued to the member 203 and the process is completed 206. If it is determined that a permanent auxiliary device should be used, the system database is checked to determine if the member has an existing permanent auxiliary device 204. If the member possesses an auxiliary device, the process is completed 206. If it is determined that the member does not possess an auxiliary device, a new one is provisioned and the member ID is associated with it in the system database 207 and it is sent to the member 205 and the process is completed 206.

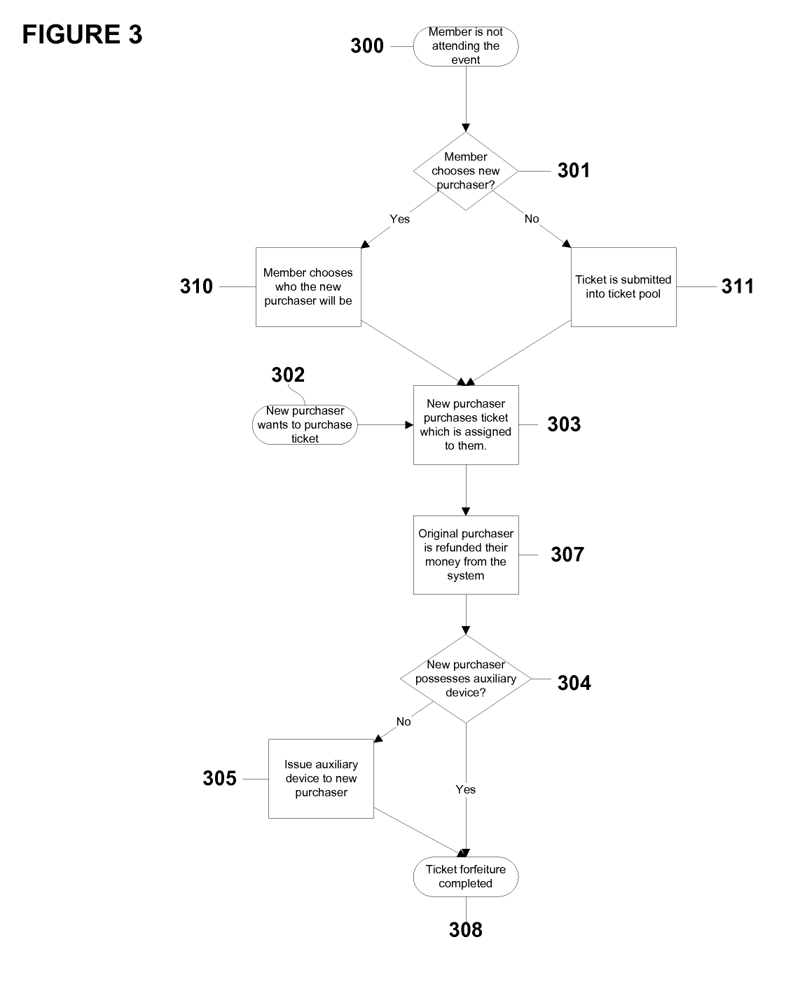

FIG. 3 is a flow chart of the ticket forfeiture process which happens when a member with a ticket will not attend. an event for any reason 300. Once the member has determined, that they are no longer able to attend an event 300, they have the option to choose who their ticket is sold to 301. If the member decides to use this option then they must choose the new purchaser 310, and the assigned new purchaser purchases the ticket 303. If the member does not choose the new purchaser, the ticket is submitted back into the available ticket pool where it is sold at face value 311. When a new purchaser who was not chosen wants to purchase a ticket 302, any forfeited tickets that have been submitted back into the pool will be sold before any unsold tickets and the new purchaser purchases the ticket and it is assigned to them 303. After the forfeited ticket has been purchased and assigned, the original purchaser is refunded. their money for the ticket 307. The system determines if the new purchaser possesses an auxiliary device 304. If the new purchaser does not possess an auxiliary device, they are issued a new one 305 and the ticket forfeiture process is completed. If the purchaser already possesses an auxiliary device then the ticket forfeiture process is completed 308.

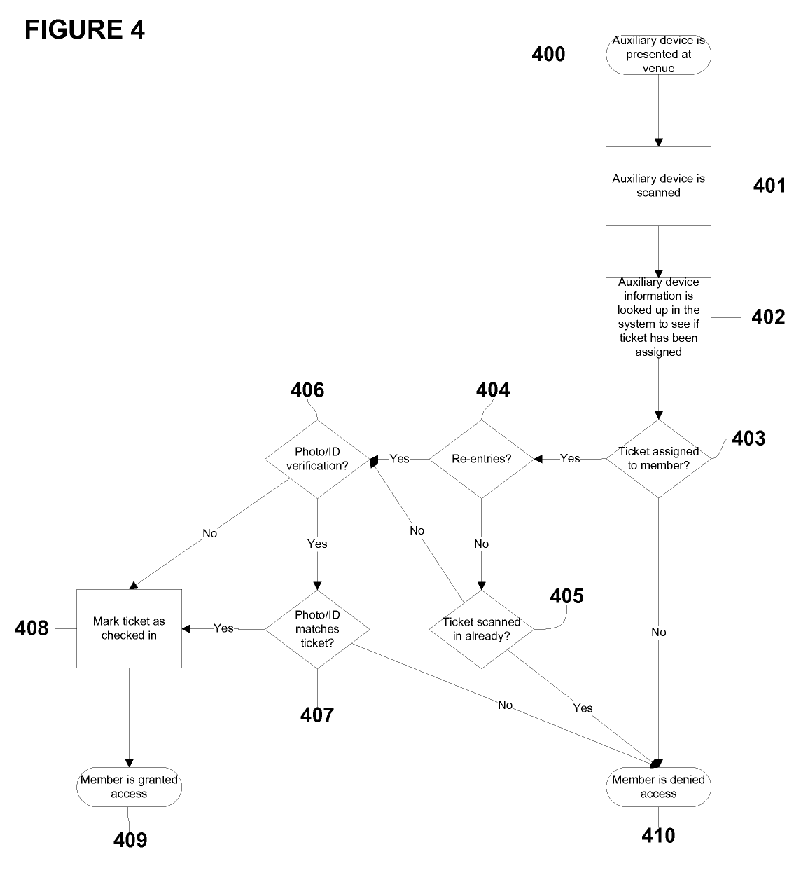

FIG. 4 is a flow chart depicting the ticket verification process that takes place at the venue. When the auxiliary device is presented to a scanner 400 it is scanned 401. The auxiliary device is searched for in the system's database to determine if a ticket for that event has been assigned to the auxiliary device 402. The system determines if there is a ticket assigned to the device being scanned 403. If there is no ticket assigned to the auxiliary device, that individual is denied access 410. If there is a ticket assigned to that device, the system checks to see if re-entry is allowed 404. “Re-entry” is defined as a feature which allows attendees to enter and exit the venue as many times as possible for whatever reason using the same ticket. If “re-entries” are not allowed, the system checks to see if the ticket assigned to the auxiliary device has been scanned in already 405. If the ticket has already been scanned and used, the individual is denied access 410. If the ticket has not been used or if re-entry is allowed, the system then determines if photo/ID verification will be used 406. If there is no photo/ID verification, the ticket is marked as “checked-in” 408 and the individual is granted access to the event 409. If there is photo/ID verification, the information of the individual will appear on the auxiliary device scanner and the individual will have to provide photo/ID verification 407. If the photo/ID cannot be verified, the individual is denied access to the event 410. If the photo/ID is verified, the ticket is marked as “checked-in” 408 and the individual is granted access to the event 409.

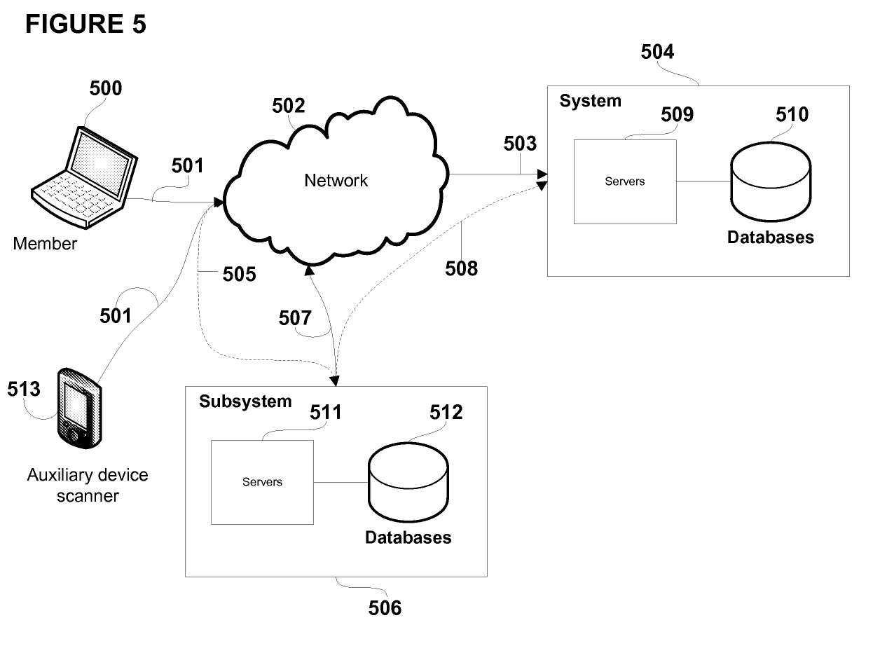

FIG. 5 is a diagram depicting how members 500 and auxiliary device scanners 513 interact with the system 504 whenever a transaction occurs. A member 500 or auxiliary device scanner 513 can communicate and interact with a system 504 directly by sending requests through 501 a network 502 where the system 504 is on the other side of the network 503. The system 504 is comprised of several servers 509 and databases 510 that interact with each other to process requests made from members 500 and auxiliary device scanners 513. These requests include, but are not limited to the processes described in FIGS. 1-4. When the system 504 is done servicing a request, it sends its response back to its originator. Alternately, a member 500 or auxiliary device scanner 513 can make a request to a subsystem 506. Similar to the system 504, the subsystem 506 is comprised of multiple servers 511 and databases 512 that interact with each other to either process requests directly or to make requests to the system 504. Subsystems 506 can be permanent or temporary installations. Subsystem 506 installs will take place at locations that request or need to be directly connected to the system 504. A member 500 or auxiliary device scanner 513 makes a request 501 to the subsystem 506 through a network 502 which is often local to the subsystem 506. The subsystem 506 can process the request itself and send the response back to the originator or it can act as a proxy for the system 504, and send the request 507 through a network 502 which has the appearance of the subsystem 506 communicating directly 508 with the system 504. The system 504 can then process the request and send the response directly to the originator or send it to the subsystem 504 and the subsystem 504 can send the response directly to the originator.

The invention claimed is:

1. A method for preventing event ticket scalping comprising of:
A process to purchase a ticket on the system requiring tie purchaser to select who they arc purchasing tickets for, if not for them self;
A process for members to forfeit tickets—re-entering them into the available ticket pool on the system negating transferability outside the system on third-party systems so their value can be controlled and the ticket can be forced to be sold at face value after which the original purchaser receives a refund for the original purchase;
A process to verify an auxiliary device's validity and authenticity by using a scanner to scan the auxiliary device and send its details to the system which the system uses to lookup the member and tickets associated with them.

2. A permanent and re-usable auxiliary device for event ticketing comprising of:
A unique identifier that is stored in the system;
An association with a single member within the system;
The ability to gain entrance to multiple events by its association with a single member and the tickets associated with that member within the system.
